(19) United States
(12) Patent Application Publication
(10) Pub. No.: US 2011/0200342 A1
(43) Pub. Date: Aug. 18, 2011

(54) IMAGE FORMING APPARATUS

(75) Inventor: Noboru Furuyama, Kanagawa-ken (JP)

(73) Assignees: KABUSHIKI KAISHA TOSHIBA, Tokyo (JP); TOSHIBA TEC KABUSHIKI KAISHA, Tokyo (JP)

(21) Appl. No.: 13/028,379

(22) Filed: Feb. 16, 2011

Related U.S. Application Data
(60) Provisional application No. 61/305,379, filed on Feb. 17, 2010.

(51) Int. Cl. G03G 15/00

(52) U.S. Cl. 399/18

(57) ABSTRACT

An image forming apparatus includes: a recording medium information acquisition portion that acquires carried recording medium information, which is information related to thickness of a recording medium to be carried as an image forming subject; a recording medium determination portion that determines whether there is a mismatch between the carried recording medium information acquired by the recording medium information acquisition portion and specified recording medium information, which is information related to thickness of a specified recording medium specified by a user as an image forming subject; a condition control portion that, if the recording medium determination portion determines the mismatch between the carried recording medium information and the specified recording medium information, changes a condition for transferring or fixing among image forming conditions corresponding to the specified recording medium to a condition for transferring or fixing corresponding to the recording medium to be carried in image formation on the recording medium to be carried; a condition change detection portion that detects a completion of a change in the condition for transferring or fixing by the condition control portion; and a carrying control portion that suspends carrying of the recording medium if the recording medium determination portion determines the mismatch between the carried recording medium information and the specified recording medium information and resumes carrying of the recording medium in response to a detection of the completion of the change in the condition for transferring or fixing by the condition change detection portion.

### CROSS-REFERENCE TO RELATED APPLICATION

This application is based upon and claims the benefit of priority from U.S. provisional application 61/305,379, filed on Feb. 17, 2010; the entire contents of which are incorporated herein by reference.

### FIELD

Embodiments described in the present specification relate to a technique for an image forming apparatus capable of using recording media of different thicknesses.

### BACKGROUND

An image forming apparatus forms images on various types of recording papers of different thicknesses as image forming subjects.

If there is a paper type mismatch between recording papers set in the image forming apparatus and specified recording papers, which are recording papers specified by the user, poor fixing, hot offset, and paper jamming occur.

### DESCRIPTION OF THE DRAWINGS

FIG. 1 is a longitudinal cross section showing the schematic configuration of an image forming apparatus of a first embodiment;

FIG. 2 is a longitudinal cross section showing the schematic configuration of a mechanism forming and transferring a toner image in the first embodiment;

FIG. 3 is a longitudinal cross section showing the schematic configuration of a fixing device provided to the image forming apparatus of the first embodiment;

FIG. 4 is a view showing an example of a screen used to specify recording papers in the first embodiment;

FIG. 5 is a view showing an example of a paper thickness table of the first embodiment;

FIG. 6 is a functional block diagram of the image forming apparatus of the first embodiment;

FIG. 7 is a view showing an example of a match condition table of the first embodiment;

FIG. 8 is a view showing an example of a mismatch condition table of the first embodiment;

FIG. 9 is a view showing an example of a screen to notify a mismatch between a type of specified recording paper and a type of recording paper to be carried in the first embodiment;

FIG. 10 is a view showing an example of a process flow in the first embodiment;

FIG. 11 is a longitudinal cross section showing the schematic configuration of a fixing device provided to an image forming apparatus of a second embodiment;

FIG. 12 is a view showing an example of a match condition table of the second embodiment;

FIG. 13 is a view showing an example of a mismatch condition table of the second embodiment;

FIG. 14 is a view showing an example of a process flow in the second embodiment;

FIG. 15 is a functional block diagram of an image forming apparatus of a third embodiment;

FIG. 16 is a view showing an example of a match condition table of the third embodiment;

FIG. 17 is a view showing an example of a mismatch condition table of the third embodiment; and

FIG. 18 is a view showing an example of a process flow in the third embodiment.

### DETAILED DESCRIPTION

### First Embodiment

An image forming apparatus of a first embodiment includes a recording medium information acquisition portion, a recording medium determination portion, a condition control portion, a condition change detection portion, and a carrying control portion.

The recording medium information acquisition portion acquires carried recording medium information, which is information relating thickness of a recording medium to be carried as an image forming subject. The recording medium determination portion determines whether there is a mismatch between the carried recording medium information acquired by the recording medium information acquisition portion and specified recording medium information, which is information relating thickness of a specified recording medium specified by a user as an image forming subject. If the recording medium determination portion determines the mismatch between the carried recording medium information and the specified recording medium information, the condition control portion changes a condition for transferring or fixing among image forming conditions corresponding to the specified recording medium to a condition for transferring or fixing corresponding to the recording medium to be carried in image formation on the recording medium to be carried. The condition change detection portion detects a completion of a change in the condition for transferring or fixing by the condition control portion. The carrying control portion suspends carrying of the recording medium if the recording medium determination portion determines the mismatch between the carried recording medium information and the specified recording medium information. Also, the carrying control portion resumes carrying of the recording medium in response to a detection of the completion of the change in the condition for transferring or fixing by the condition change detection portion.

Hereinafter, the first embodiment will be described concretely using the drawings. The following describes recording papers as an example of the recording medium. The recording medium information acquisition portion and the recording medium determination portion are therefore referred to as a recording paper information acquisition portion and a recording paper determination portion, respectively, in descriptions of functional blocks below. Also, the carried recording medium information is referred to as carried recording paper information.

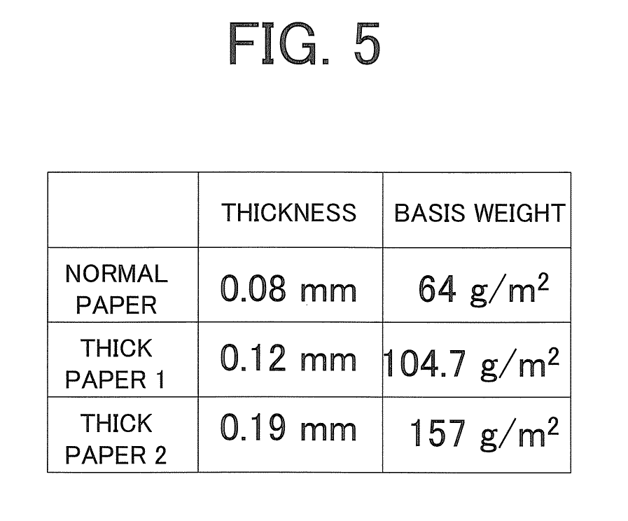

Further, for ease of understanding, the following describes a normal paper, a thick paper 1, and a thick paper 2 having thicknesses and basis weights set forth in FIG. 5 as described below as examples of the types of recording paper. In the first embodiment, examples of the information related to thickness include an actual thickness (hereinafter, referred to simply as the thickness) of the recording paper expressed, for example, in millimeters, and a basis weight (expressed in units of g/m²) of the recording paper indicating the weight per square meter of paper.

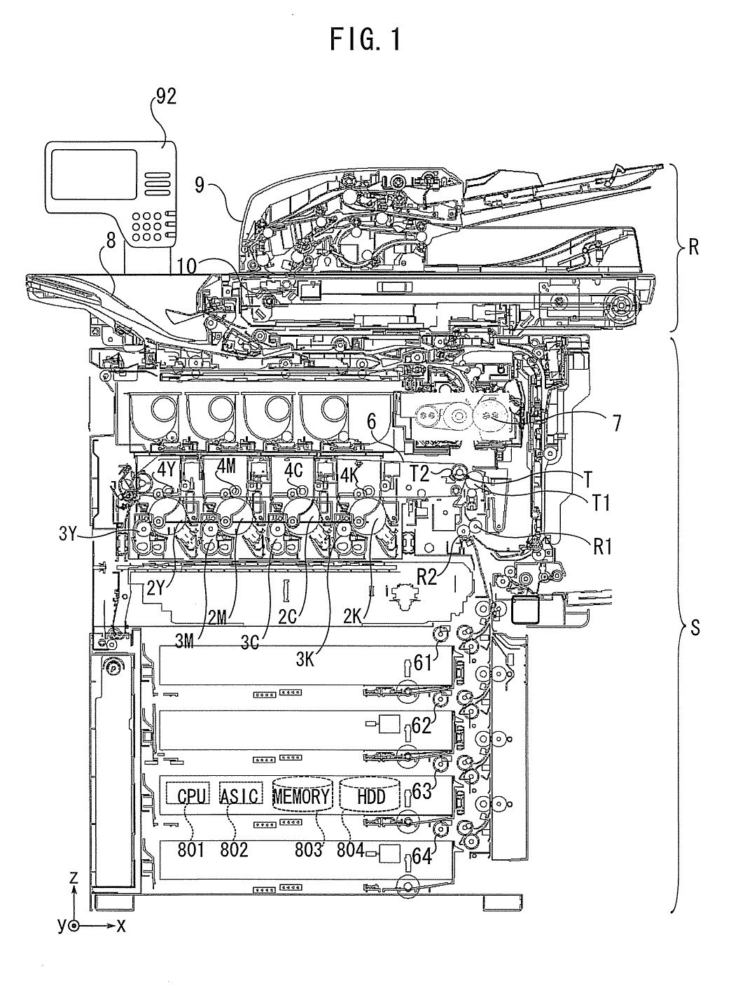

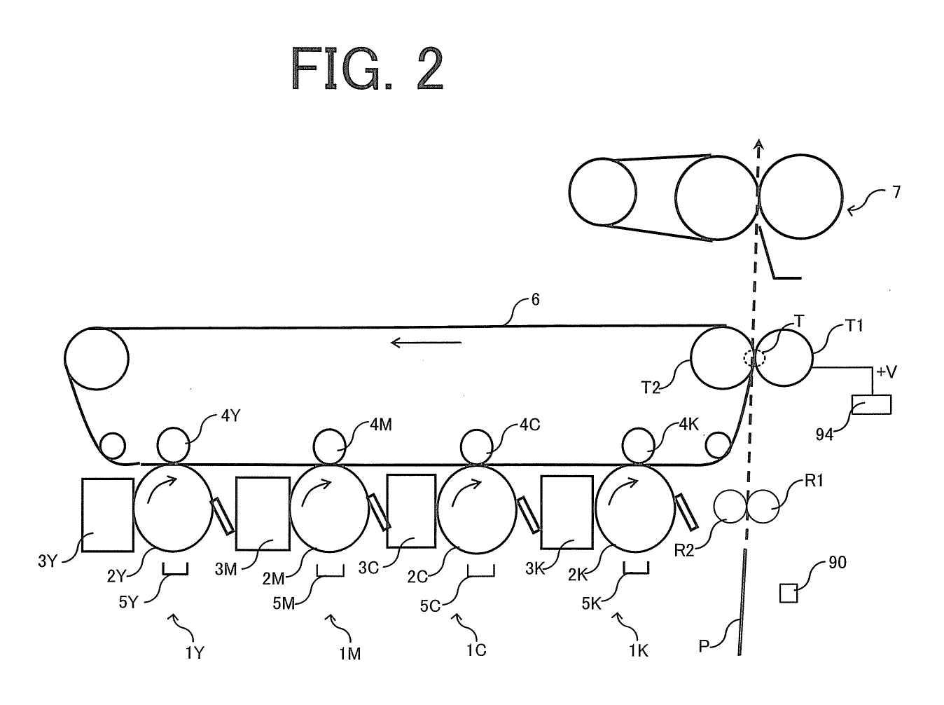

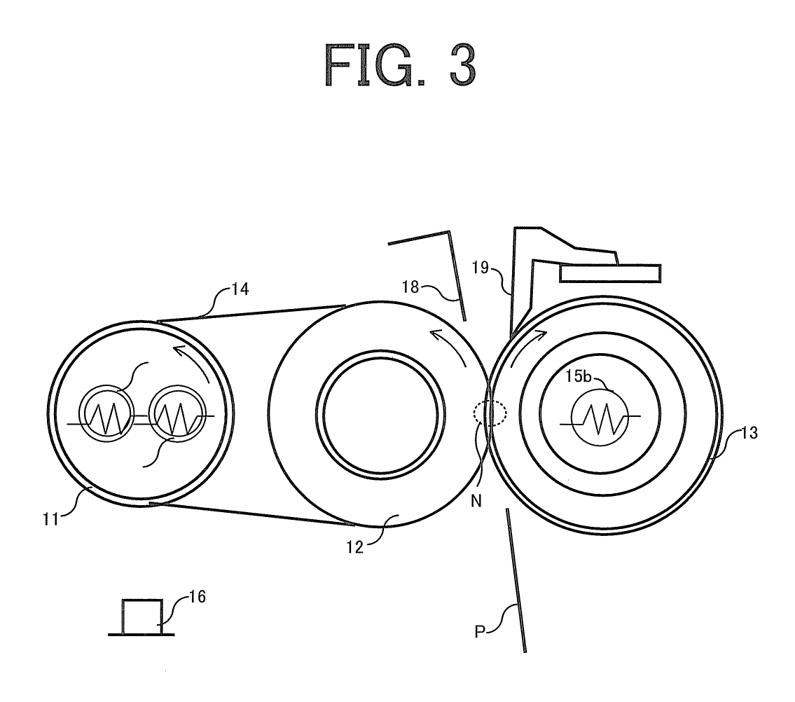

FIG. 1 is a longitudinal cross section showing the schematic configuration of the image forming apparatus (MFP: Multi Function Peripheral) of the first embodiment. FIG. 2 is a longitudinal cross section showing the schematic configuration of a mechanism forming and transferring a toner image in the MFP. FIG. 3 is a longitudinal cross section showing the schematic configuration of a fixing device incorporated in the MFP of the first embodiment.

As is shown in FIG. 1, the MFP includes an image reading portion R and an image forming portion S.

The image reading portion R has a function of scanning across a sheet document and a book document to read an image thereon.

The image forming portion S has a function of forming a developer image on a recoding paper P according to an image read from a document by the image reading portion R and image data sent to the MFP from an outside apparatus.

The image reading portion R includes an automatic document carrying device (ADF: Auto Document Feeder) 9 capable of automatically carrying a document to a predetermined image reading position, and reads a document automatically carried by the ADF 9 and an image on a document placed on a document table using a scanning optical system 10.

The image forming portion S includes pick-up rollers 61 through 64, a yellow station 1Y, a magenta station 1M, a cyan station 1C, a black station 1K, a fixing device 7, and a discharge tray 8.

The yellow station 1Y includes a photoconductor 2Y, a developing device 3Y, and a primary transfer roller 4Y and transfers a yellow toner image onto an intermediate transfer belt 6. Likewise, the magenta station 1M, the cyan station 1C, and the black station 1K include photoconductors 2M, 2C, and 2K, developing devices 3M, 3C, and 3K, and primary transfer rollers 4M, 4C, and 4K, respectively, and transfer toner images onto the intermediate transfer belt 6.

The MFP of the first embodiment also includes a CPU 801, an ASIC (Application Specific Integrated Circuit) 802, a MEMORY 803, and an HDD (Hard Disk Drive) 804. The CPU 801 performs various types of processing in the MFP and also achieves various functions by running programs temporarily stored in the MEMORY 803. It goes without saying that an MPU (Micro Processing Unit) capable of executing comparable arithmetic processing can be used as an alternative to the CPU 801. Likewise, a memory device, for example, a flash memory can be used as an alternative to the HDD 804.

On the ASIC 802, hardware (circuits) controlling various functions provided to the MFP is mounted.

The MEMORY 803 can be formed, for example, of a RAM (Random Access Memory), a ROM (Read Only Memory), a DRAM (Dynamic Random Access Memory), an SRAM (Static Random Access Memory), and a VRAM (Video RAM) and temporarily stores various types of information and programs used in the MFP and log information of executed processing. For example, the CPU 801 reads out a program and data stored in the HDD 804 to the MEMORY 803. The CPU 801 executes processing using the program and the data read out to the MEMORY 803. Also, the CPU 801 stores information generated during the processing, for example, log information of the processing and information on the number of sheets, in the MEMORY 803.

The MFP of the first embodiment has an operation portion 92 enabling the user to input requests for various types of processing to the MFP. The operation portion 92 is formed of a power supply switch switching over electrical conduction states (ON and OFF) from an unillustrated power supply to the MFP, a graphical display with a mounted touch panel sensor, frequently used processing input buttons, such as digits keys and start and cancel keys, and a status display LED.

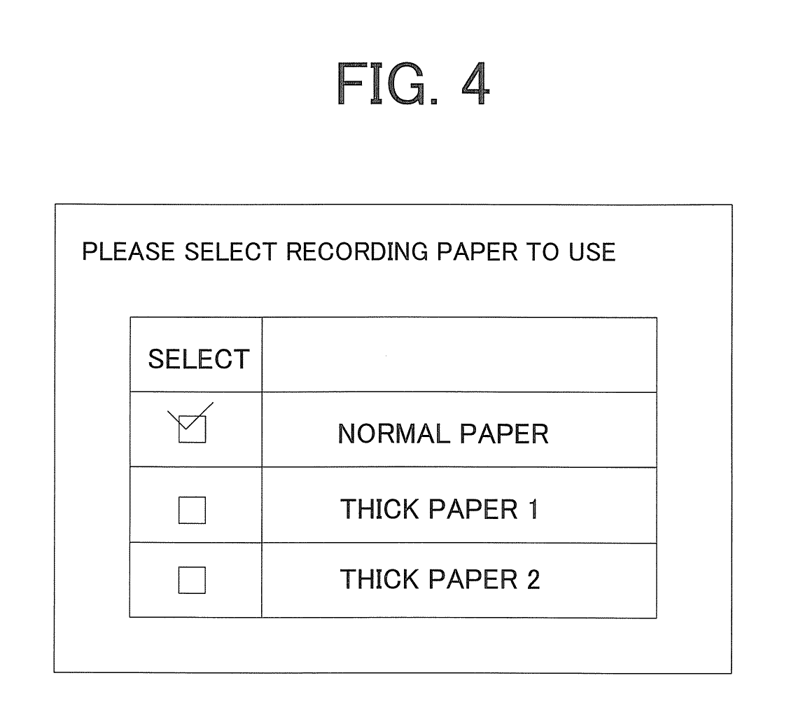

For example, upon receipt of a request for image formation from the user, the MFP displays a screen on the display of the operation portion 92 as the one shown in FIG. 4, requesting an input by the user to specify the type of recording papers the user specifies. The MFP acquires information on specification of the type of specified recording papers from the user via an input of the user using this screen. The MFP then generates specified recording paper information from the acquired information on the specification and information on thickness or basis weight of recording papers type by type. Information on thickness or basis weight of recording papers type by type is, for example, a paper thickness table shown in FIG. 5 by way of example in which thicknesses and basis weights are correlated with types of recording papers. The paper thickness table may be pre-stored in the HDD 804 or obtained from the outside of the MFP via a network. The specified recording paper information is stored in a memory portion 21 described below.

Hereinafter, a general idea of image formation by the MFP of the first embodiment will be described.

Initially, the pick-up rollers 61 through 64 pick up a recording paper P from a cassette to be fed into a sheet carrying path. A plurality of roller pairs then carry the recording paper P fed into the sheet carrying path to a predetermined carrying direction.

The scanning optical system 10 reads an image on a sheet document at a predetermined image reading position.

In the MFP, the charging device 5Y charges the outer circumference surface of the photoconductor 2Y provided in the yellow station 1Y and rotating in the direction indicated by an arrow of FIG. 2. An unillustrated exposing device exposes the charged photoconductor 2Y to light using a laser beam to form an electrostatic latent image. The developing device 3Y develops the electrostatic latent image into a yellow toner image. Thereafter, the yellow toner image on the photoconductor 2Y is transferred onto the intermediate transfer belt 6 in a transfer region of the yellow station 1Y formed of the intermediate transfer belt 6, the primary transfer roller 4Y, and the photoconductor 2Y by an action of a bias applied from the primary transfer roller 4Y. A photoconductor cleaner removes residual toner that is not transferred and remains on the photoconductor 2Y and the charging device 5Y charges the photoconductor 2Y again to repeat the operation as above.

Likewise, a magenta toner image is developed in the magenta station 1Y, a cyan toner image is developed in the cyan station 1C, and a black toner image is developed in the black station 1K. After the yellow toner image is transferred thereon, the intermediate transfer belt 6 is successively carried to the transfer regions in the stations of the respective colors so that the magenta toner image, the cyan toner image, and the black toner image are transferred thereon.

Meanwhile, a tilt of the fed recording paper P is corrected as the tip end of the recording paper P butts against an abutting portion of registration rollers R1 and R2 that suspend rotations. The registration rollers R1 and R2 resume rotations in synchronization with the toner images and the recording paper P is carried to a secondary transfer region T formed of the intermediate transfer belt 6, a secondary transfer roller T1, and a counter roller T2. In the secondary transfer region T, the yellow, magenta, cyan and black toner images formed on the intermediate transfer belt 6 are transferred onto the recording paper P by an action of a transfer bias applied to the secondary transfer roller T1 from a transfer bias application power supply 94. The recording paper P on which are transferred toners of the respective colors is carried to a fixing position (nip portion N) of the fixing device 7.

The MFP of the first embodiment includes a paper thickness sensor 90 disposed upstream of the registration rollers R1 and R2 in the carrying direction at a position not to come into contact with the recording paper P and acquiring the carried recording paper information, which is information on thickness or basis weight of the recording paper to be carried. More concretely, the paper thickness sensor 90 can be a micro-displacement sensor measuring a thickness from an amount of displacement when the recording paper P passes by the sensor or a radiation sensor irradiating the recording paper P and measuring a basis weight from an amount of radiation attenuated when passing through the recording paper P.

As is shown in FIG. 3, the fixing device 7 includes a heating roller 11, a fixing roller 12, a pressure roller 13, a fixing belt 14, halogen heaters 15a and 15b, and a non-contact temperature sensor 16.

The fixing belt 14 is put across the heating roller 11 and the fixing roller 12 and a tension mechanism pulls the fixing belt 14 over the heating roller 11 and the fixing roller 12 with a predetermined tensile force.

A drive motor (not shown) drives the heating roller 11 in the direction indicated by an arrow. The fixing roller 12 and the fixing belt 14 rotate in association with rotations of the heating roller 11 in the direction indicated by an arrow. Also, a pressure mechanism presses the pressure roller 13 (corresponding to a pressure member) against the fixing roller 12 with the fixing belt 14 in between so as to maintain a constant nip width. Hence, the pressure roller 13 also rotates in association with rotations of the heating roller 11 in the direction indicated by an arrow. In the first embodiment, the heating roller 11 and the fixing belt 14 correspond to a heating member.

The fixing roller 12 is formed by providing a heat-resistant elastic layer made, for example, of silicon sponge, on a cored bar. Also, the pressure roller 13 is formed by coating a hollow aluminum or iron cored bar with silicon rubber and coating the outside with a PFA tube. A hardness of the pressure roller 13 is set higher than a hardness of the fixing roller 12.

The halogen heaters 15a as a heat generation source are disposed inside the heating roller 11. Also, the halogen heater 15b as a heat generation source is disposed on the inner side of the pressure roller 13.

As the recording paper P passes by the fixing position, which is the pressing portion (nip portion N) of the fixing roller 12, the fixing belt 14, and the pressure roller 13, toners on the recording paper P are fixed thereon by fusing and pressing.

In the first embodiment, the MFP includes the temperature sensor 16 detecting a temperature of the fixing belt 14 in close proximity to the surface of the fixing belt 14. In the present specification, the temperature of the fixing belt 14 detected by the temperature sensor 16 is referred to as the fixing temperature.

Further, on the outer circumference of the fixing belt 14, the MFP includes a separation plate 18 (corresponding to a separation guide) disposed downstream of the nip portion N in the rotation direction at a position opposing the fixing belt 14 and separating the recording paper P from the belt surface of the fixing belt 14 to guide the recording paper P. Likewise, the MFP includes a separation plate 19 disposed downstream of the nip portion N in the rotation direction at a position opposing the pressure roller 13 and separating the recording paper P from the pressure roller 13.

Functional blocks relating to the control on image formation corresponding to a type of recording paper in the first embodiment will now be described.

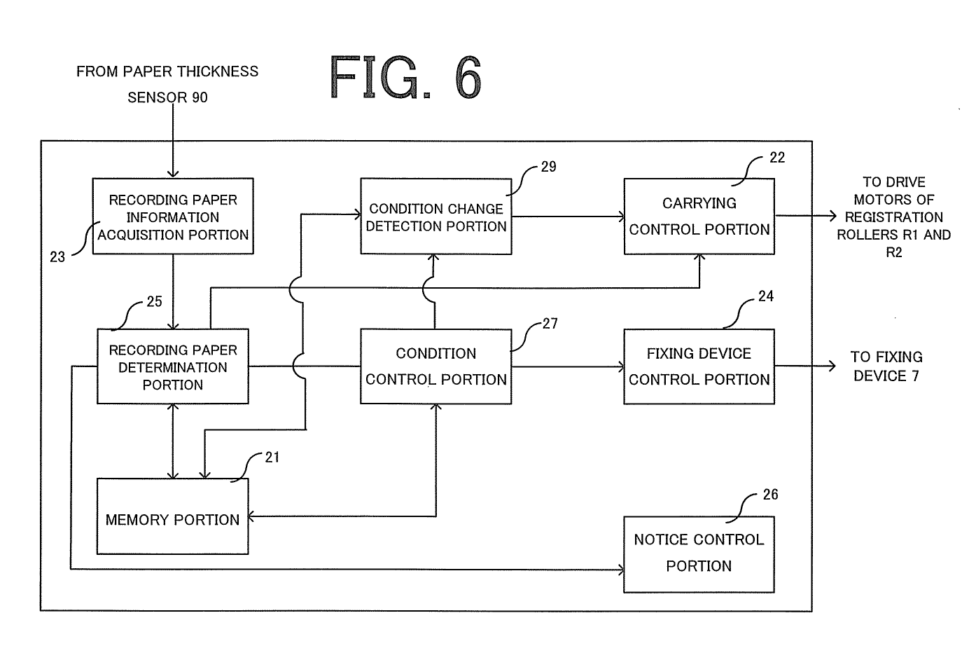

As is shown in FIG. 6, the MFP of the first embodiment includes a memory portion 21, a recording paper information acquisition portion 23, a recording paper determination portion 25, a condition control portion 27, a condition change detection portion 29, a carrying control portion 22, a fixing device control portion 24, and a notice control portion 26. The respective functional blocks can be achieved, for example, by running programs read out to the MEMORY 803 on the CPU 801.

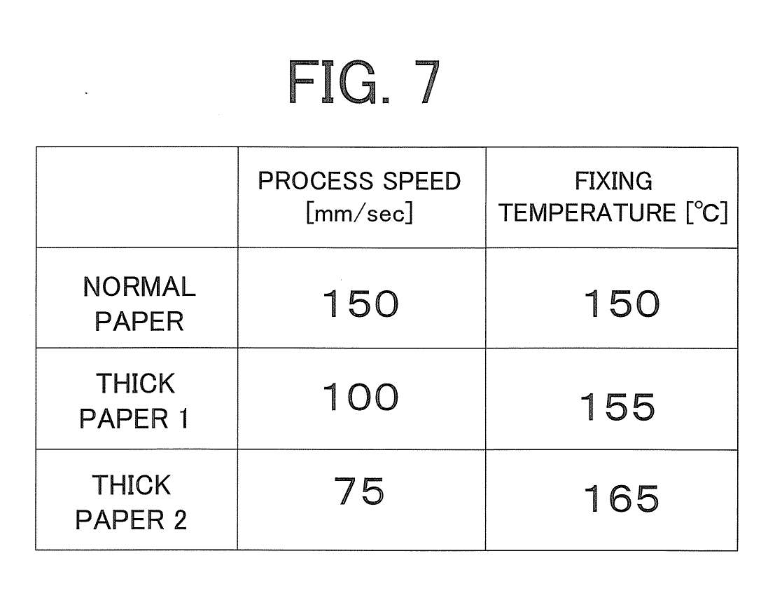

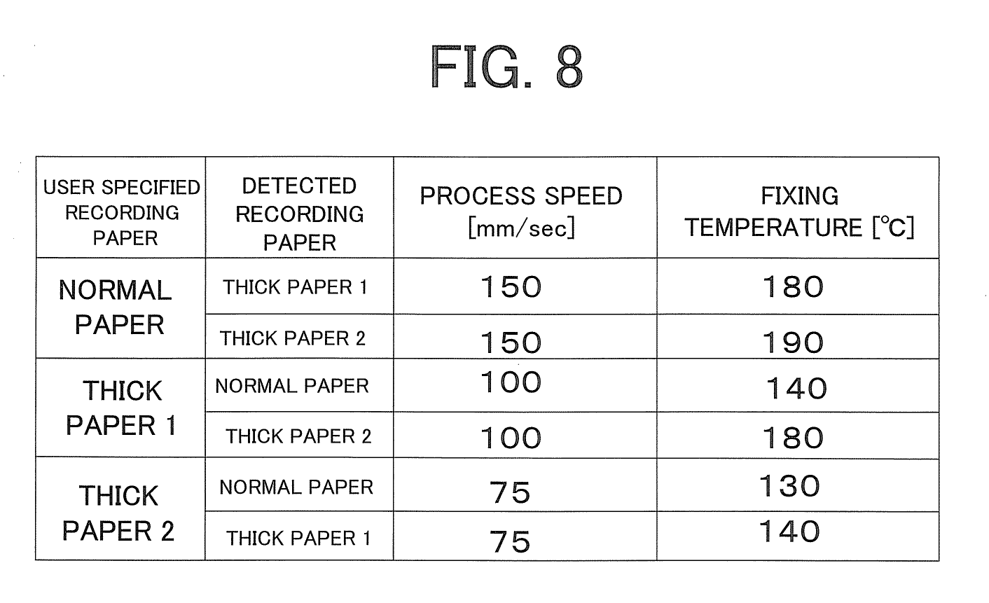

The memory portion 21 stores the specified recording paper information, the match condition table shown in FIG. 7 by way of example, and the mismatch condition table shown in FIG. 8 by way of example. In the match condition table, types of recording paper to be carried are correlated with carrying speeds and fixing temperatures when specified recording paper information (described below) on specified recording papers specified by the user as an image forming subject matches with carried recording paper information (described below) on recording papers to be carried. In the mismatch condition table, types of specified recording paper are correlated with types of recording paper P to be carried, carrying speeds, and fixing temperatures when there is a mismatch between the specified recording paper information and the carried recording paper information.

The recording paper information acquisition portion 23 acquires carried recording paper information, which is information on thickness or basis weight of the recording paper P to be carried as an image forming subject, from the paper thickness sensor 90 and sends the acquired information to the recording paper determination portion 25.

The recording paper determination portion 25 determines whether the carried recording paper information acquired by the recording paper information acquisition portion 23 matches with the specified recording paper information stored in the memory portion 21, which is information on thickness or basis weight of the recording paper specified by the user as the image forming subject. More concretely, the recording paper determination portion 25 determines, for example, whether a value of the thickness (or basis weight) of the recording paper P indicated by the carried recording paper information matches with a value of the thickness (or basis weight) of the recording paper specified by the user indicated by the specified recording paper information.

Upon determination that there is a mismatch between the carried recording paper information and the specified recording paper information, the recording paper determination portion 25 notifies the condition control portion 27, the notice control portion 26, and the carrying control portion 22 of a mismatch as the determination result. Further, the recording paper determination portion 25 sends the carried recording paper information together with the notice of the determination result to the condition control portion 27.

If the recording paper determination portion 25 determines a mismatch between the carried recording paper information and the specified recording paper information, the condition control portion 27 changes the condition for transferring or fixing among the image forming conditions corresponding to the specified recording paper to the condition for transferring or fixing corresponding to the recording paper P to be carried using the carried recording paper information acquired from the recording paper determination portion 25, the specified recording paper information stored in the memory portion 21, and the mismatch condition table stored in the memory portion 21.

More concretely, the condition control portion 27 controls the fixing device control portion 24 to change the fixing temperature of the fixing device 7 provided to the MFP among the image forming conditions corresponding to the specified recording paper to the fixing temperature corresponding to the recording paper P to be carried.

As can be understood from FIG. 7 and FIG. 8, if the recording paper P to be carried is the thick paper 1 and the specified recording paper is the normal paper, the fixing temperature is set to 180° C., which is higher than 155° C. as the fixing temperature set when the thick paper 1 is the specified recording paper. In other words, in the first embodiment, if the value of the thickness or the basis weight of the recording paper P to be carried is larger than that of the specified recording paper, the fixing temperature is set to a temperature higher than the temperature set when the recording paper P to be carried is set as the specified recording paper. Also, if the recording paper P to be carried is the normal paper and the specified recording paper is the thick paper 1, the fixing temperature is set to 140° C., which is lower than 150° C. as the fixing temperature set when the normal paper is the specified recording paper. In other words, in the first embodiment, if a value of the thickness or the basis weight of the recording paper P to be carried is smaller than that of the specified recording paper, the fixing temperature is set to a temperature lower than the fixing temperature set when the recoding paper P to be carried is set as the specified recording paper.

The condition control portion 27 controls the fixing device control portion 24 and also sends the carried recording paper information to the condition change detection portion 29.

The fixing control portion 24 controls an operation state of the fixing device 7 under the control of the condition control portion 27. More concretely, the fixing control portion 24 controls the fixing temperature of the fixing device 7 under the control of the condition control portion 27.

The condition change detection portion 29 detects a completion of a change in the condition for transferring or fixing according to a change in the condition by the condition control portion 27. More concretely, in the first embodiment, the condition change detection portion 29 acquires the carried recording paper information from the condition control portion first. Subsequently, the condition change detection portion 29 acquires the fixing temperature from the non-contact temperature sensor 16 and detects that the fixing temperature reaches the changed fixing temperature using the carried recording paper information, the specified recording paper information stored in the memory portion 21, and the mismatch condition table stored in the memory 21. Also, the condition change detection portion 29 notifies the carrying control portion 22 of the detection of a completion of the change in the condition.

The carrying control portion 22 controls unillustrated drive motors of the registration rollers R1 and R2 to suspend carrying of the recording paper P according to the notice from the recording paper determination portion 25, informing the determination that there is a mismatch between the carried recording paper information and the specified recording paper information.

The carrying control portion 22 controls the drive motors of the registration rollers R1 and R2 to resume carrying of the recording paper P according to the notice from the condition change detection portion 29, informing the detection of a completion of the change in the condition for transferring or fixing. More concretely, the carrying control portion 22 controls the drive motors of the registration rollers R1 and R2 to resume carrying of the recording paper P according to the notice from the condition change detection portion 29, informing the detection of a completion of the change in the condition.

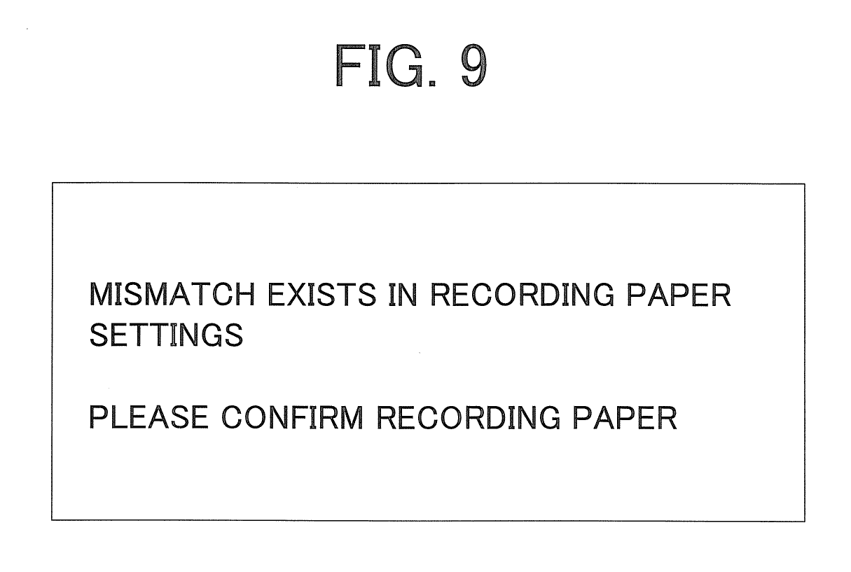

The notice control portion 26 notifies the user of the determination result of the recording paper determination portion 25 if the recording paper determination portion 25 determines a mismatch between the carried recording paper information and the specified recording paper information. More concretely, the notice control portion 26 displays a message on the display of the operation portion 92 in response to the notice from the recording paper determination portion 25. The message may have content, for example, as the one shown in FIG. 9, notifying that the type of specified recording paper differs from the type of recording paper P to be carried on the basis of a mismatch between the carried recording paper information and the specified recording paper information.

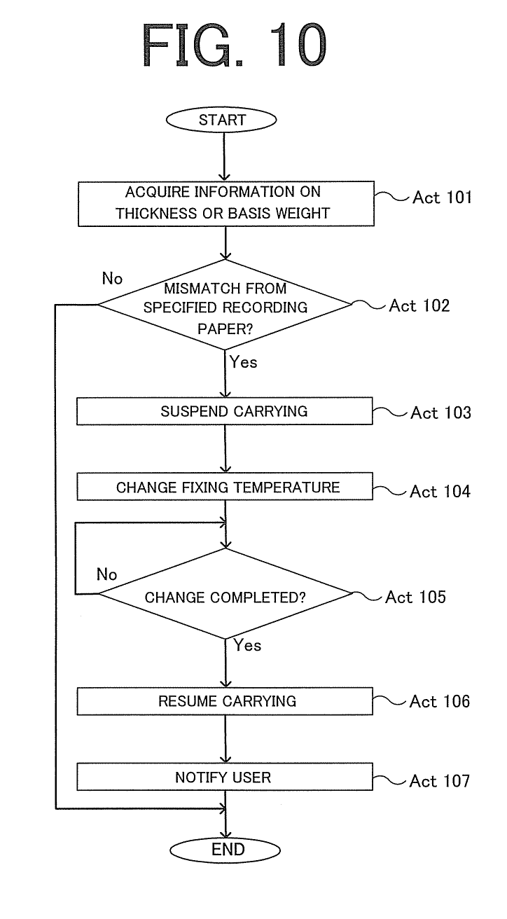

The process flow of the control on image formation corresponding to a type of recording paper in the first embodiment will now be described using FIG. 10.

In Act 101, the recording paper information acquisition portion 23 acquires the carried recording paper information from the paper thickness sensor 90 and sends the acquired information to the recording paper determination portion 25.

In Act 102, the recording paper determination portion 25 determines whether there is a mismatch between the carried recording paper information acquired from the recording paper information acquisition portion 23 and the specified recording paper information stored in the memory portion 21.

If there is no mismatch between the specified recording paper information and the carried recording paper information, the MFP ends the changing of the image forming conditions (END). In this case, the MFP sets the fixing temperature of the fixing device 7 using the match condition table shown in FIG. 7 by way of example and stored in the memory portion 21 and forms an image on the recording paper P.

Meanwhile, if there is a mismatch between the type of the specified recording paper and the type of the recording paper P to be carried in Act 102, the recording paper determination portion 25 notifies the condition control portion 27, the carrying control portion 22, and the notice control portion 26 of the determination result. Further, the recording paper determination portion 25 sends the carried recording paper information together with the notice to the condition control portion 27. The carrying control portion 22 controls the drive motors of the registration rollers R1 and R2 to suspend carrying of the recording paper P according to the notice from the recording paper determination portion 25 (Act 103).

In Act 104, according to the notice from the recording paper determination portion 25, the condition control portion changes the fixing temperature from the temperature corresponding to the specified recording paper to the temperature corresponding to the recording paper P to be carried using the carried recording paper information acquired, the specified recording paper information stored in the memory portion 21, and the mismatch condition table stored in the memory portion 21.

For example, assume that the specified recording paper is the normal paper whereas the recording paper P to be carried is the thick paper 1. In this instance, the condition control portion 27 controls the fixing device control proton 24 to change the fixing temperature from 150° C. to 180° C. using the mismatch condition table. Also, the condition control portion 27 sends the carried recording paper information to the condition change detection portion 29.

In Act 105, the condition change detection portion 29 determines whether the change is completed and detects a completion of the change upon determination of a completion of the change. More concretely, the condition change detection portion 29 determines whether the fixing temperature reaches the changed temperature using the carried recording paper information acquired from the condition control portion 27, the specified recording paper information stored in the memory portion 21, and the mismatch condition table stored in the memory portion 21. If the fixing temperature does not reach the changed temperature, the condition change detection portion 29 continues the processing in Act 105. Meanwhile, if the fixing temperature reaches the changed temperature, the condition change detection portion 29 notifies the carrying control portion 22 of a completion of the change. In Act 106, the carrying control portion 22 controls the drive motors of the registration rollers R1 and R2 to resume carrying of the recording paper P according to the notice from the condition change detection portion 29. In Act 107, the notice control portion 26 notifies the user of a mismatch between the type of the specified recording paper and the type of the recording paper P to be carried according to the notice from the recording paper determination portion 25.

According to the MFP of the first embedment, even if there is a mismatch between the information related to thickness of the specified recording paper and the information related to thickness of the recording paper to be carried, it is possible to suppress the occurrence of hot offset and paper jamming caused by winding by changing the fixing temperature in the fixing device to the temperature corresponding to the recording paper to be carried.

### Second Embodiment

A second embodiment will now be described. Components common with the first embodiment above are labeled with the same reference numerals and descriptions thereof are omitted herein (the same applies to embodiments below).

In the second embodiment, the fixing device 7 provided to the MFP has a drive mechanism changing the installed position of the pressure roller 13 (hereinafter, referred to simply as the drive mechanism of the pressure roller 13) in addition to the configuration described in the first embodiment above and therefore has a configuration to change the magnitude of a pressure (hereinafter referred to as the fixing pressure) conferred to the recording paper P nipped between the fixing belt 14 and the pressure roller 13 as the pressure roller 13 presses against the fixing belt 14. Further, the fixing device 7 has a drive mechanism changing the installed position of the separation plate 18 (hereinafter, referred to simply as the drive mechanism of the separation plate 18) and therefore has a configuration to change a distance between the separation plate 18 and the nip portion N.

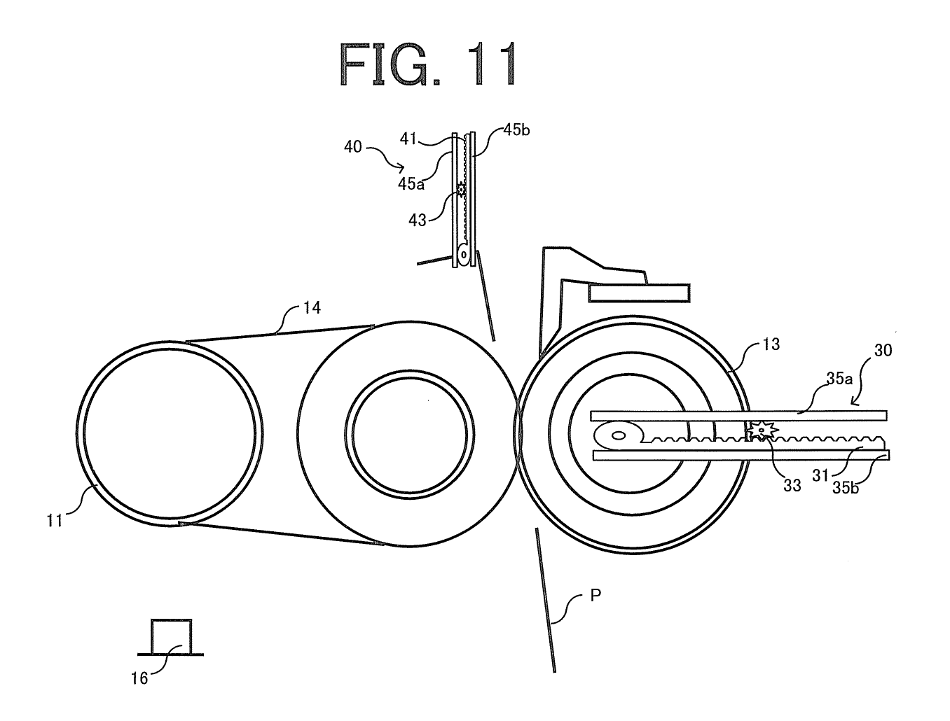

FIG. 11 is a schematic view showing the configuration of the fixing device 7 provided to the MFP of the second embodiment. Although it is not shown in the drawing for ease of understanding, as in the first embodiment above, the halogen heaters 15a are disposed inside the heating roller 11 and the halogen heater 15b is disposed inside the pressure roller 13.

The drive mechanism 30 of the pressure roller 13 can be, for example, a pinion and rack mechanism. Referring to FIG. 11, the drive mechanism 30 of the pressure roller 13 includes a rack 31 coupled to the pressure roller 13, a pinion gear 33, linear guides 35a and 35b, and an unillustrated drive motor linked to the pinion gear 33. As the drive motor operates and the pinion gear 33 starts to rotate, the pressure roller 13 moves and changes the position thereof. This consequently changes the magnitude of the fixing pressure conferred to the recording paper P in the nip portion N.

Likewise, the drive mechanism 40 of the separation plate 18 can be a pinion and rack mechanism including a rack 41 coupled to the separation plate 18, a pinion gear 43, linear guides 45a and 45b, and an unillustrated drive motor linked to the pinion gear 43.

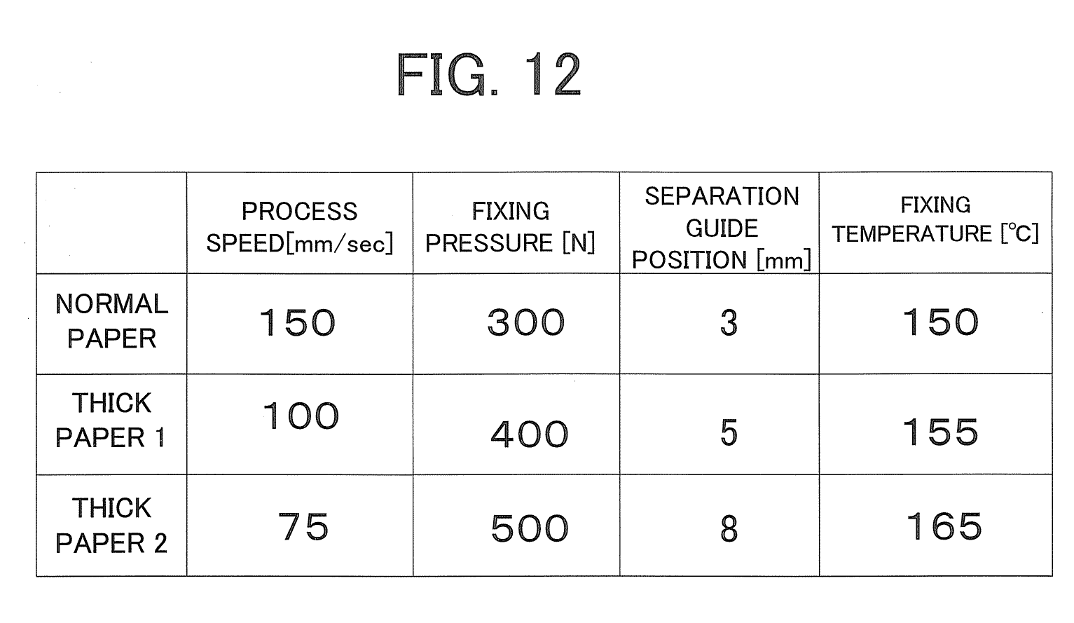

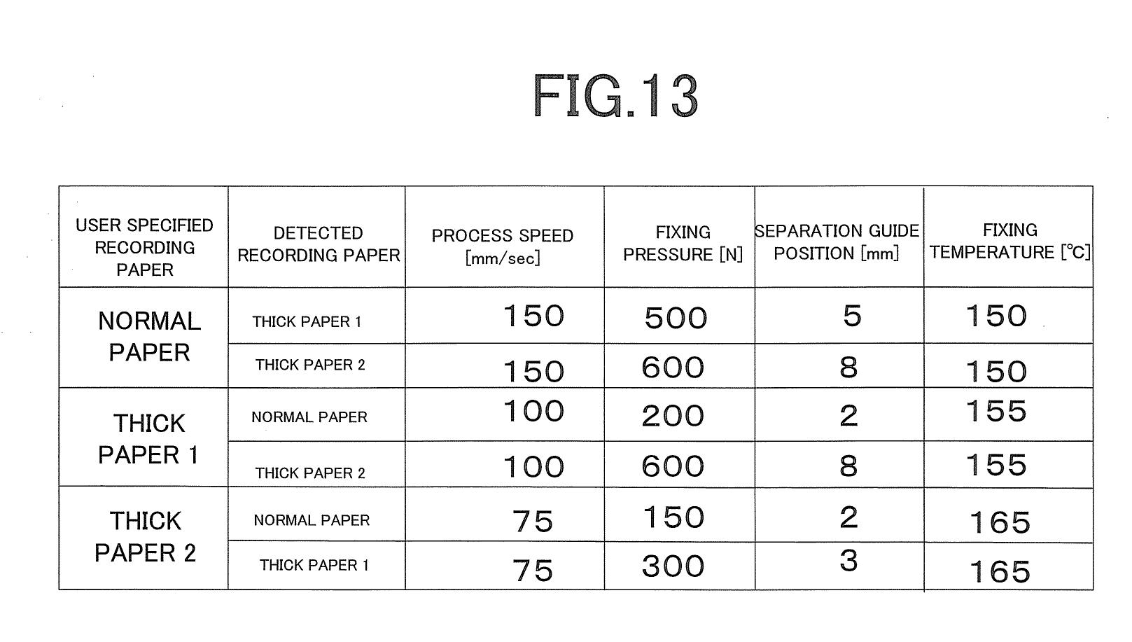

FIG. 12 is a view showing an example of a match condition table of the second embodiment. FIG. 13 is a view showing an example of a mismatch condition table of the second embodiment. As is shown in FIG. 13, in the second embodiment, instead of the fixing temperature, the magnitude of the fixing pressure and the distance between the separation plate 18 and the nip portion N are correlated with the types of the specified recording paper and the types of the recording paper P to be carried.

In the second embodiment, the MFP has functional blocks common with the first embodiment above for the control on the image formation corresponding to a type of recording paper. Accordingly, the following describes only a difference from the first embodiment above.

In the second embodiment, the condition control portion 27 controls the fixing device control portion 24 to change, instead of the fixing temperature, the magnitude of the fixing pressure and the distance between the separation plate 18 and the nip portion N that changes with the position of the separation plate 18. The fixing device control portion 24 changes the position of the pressure roller 13 and the position of the separation plate 18 by controlling the drive motor of the drive mechanism 30 of the pressure roller 13 and the drive motor of the drive mechanism 40 of the separation plate 18, respectively.

The condition change detection portion 29 detects a completion of the change upon detection that the drive motor of the drive mechanism 30 of the pressure roller 13 and the drive motor of the drive mechanism 40 of the separation plate 18 are at rest.

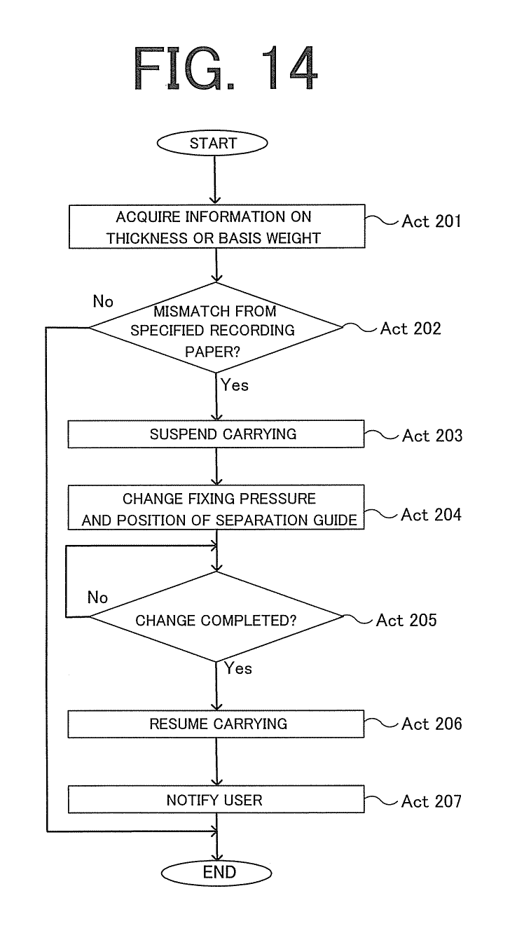

The process flow of the control on the image formation corresponding to a type of recording paper in the second embodiment will now be described using FIG. 14.

Because the contents of processing in Act 201 through Act 203 are common with those in Act 101 through Act 103 in the first embodiment above and the content of processing in Act 207 is common with that in Act 107 in the first embodiment, descriptions thereof are omitted herein.

In Act 204, the condition control portion 27 changes the magnitude of the fixing pressure from the magnitude corresponding to the specified recording paper to the magnitude corresponding to the recording paper P to be carried using the carried recording paper information, the specified recording paper information, and the mismatch condition table according to the notice from the recording paper determination portion 25. Further, the condition control portion 27 changes the distance between the separation plate 18 and the nip portion N from a length corresponding to the specified recording paper to a length corresponding to the recording paper P to be carried by changing the position of the separation plate 18 using the carried recording paper information, the specified recording paper information, and the mismatch condition table.

For example, assume that the specified recording paper is the thick paper 1 whereas the recording paper P to be carried is the normal paper. In this instance, the condition control portion 27 controls the fixing device control portion 24 to change the fixing pressure from 500 N to 200 N using the carried recording paper information, the specified recording paper information, and the mismatch condition table. Also, the condition control portion 27 controls the fixing device control portion 24 to move the separation plate 18 to a position at which the distance between the separation plate 18 and the nip portion N is changed from 5 mm to 2 mm using the mismatch condition table. Further, the condition control portion 27 sends the carried recording paper information to the condition change detection portion 29. In other words, the condition control portion 27 shortens the distance between the separation plate 18 and the nip portion N upon determination that the thickness or the basis weight of the recording paper P to be carried is less than that of the specified recording paper using the carried recording paper information, the specified recording paper information, and the mismatch condition table.

In Act 205, the condition change detection portion 29 acquires information on driving states of the drive motor of the drive mechanism 30 of the pressure roller 13 and the drive motor of the drive mechanism 40 of the separation plate 18 by the acquisition of the change information from the condition control portion 27 and determines whether the drive motors stop driving according to the acquired information. If at least one of the drive motor of the drive mechanism 30 of the pressure roller 13 and the drive motor of the drive mechanism 40 of the separation plate 18 is still driving, the condition change detection portion 29 continues the processing in Act 205. Meanwhile, if the drive motor of the drive mechanism 30 of the pressure roller 13 and the drive motor of the drive mechanism 40 of the separation plate 18 stop driving, the condition change detection portion 29 notifies the carrying control portion 22 of a completion of the change. In Act 206, the carrying control portion 22 controls the drive motors of the registration rollers R1 and R2 to resume carrying of the recording paper P according to the notice from the condition change detection portion 29.

In this manner, if there is a mismatch between the information on thickness or basis weight of the specified recording paper and the information on thickness or basis weight of the recording paper P to be carried, the MFP of the second embodiment changes the magnitude of the fixing pressure in the fixing device 7 to the magnitude corresponding to the recording paper P to be carried and also changes the length between the separation plate 18 and the nip portion N to the length corresponding to the recording paper P to be carried. It thus becomes possible to suppress the occurrence of hot offset and paper jamming caused by winding.

### Third Embodiment

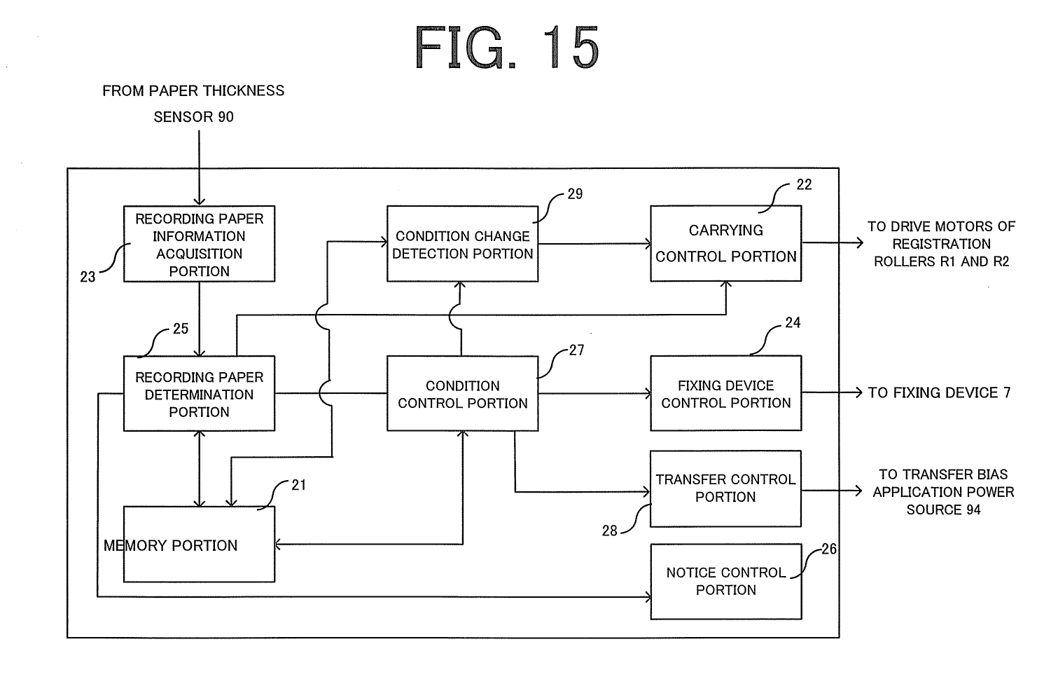

FIG. 15 is a view showing the functional blocks relating to the control on the image formation according to a type of recording paper in the third embodiment. The MFP of the third embodiment includes a transfer control portion 28 in addition to the configuration described in the first embodiment above.

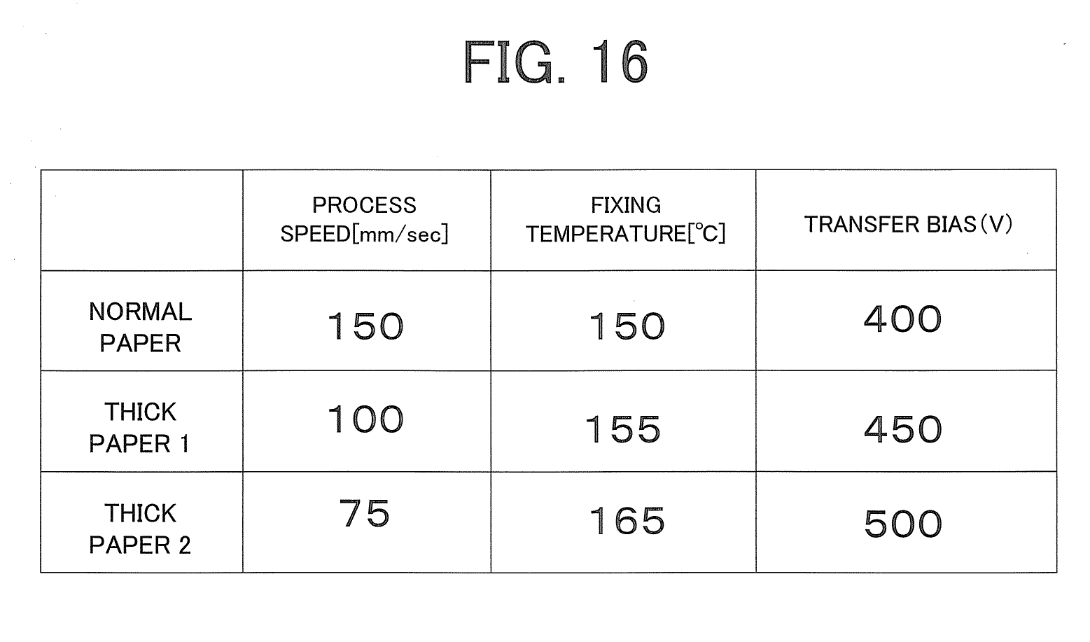

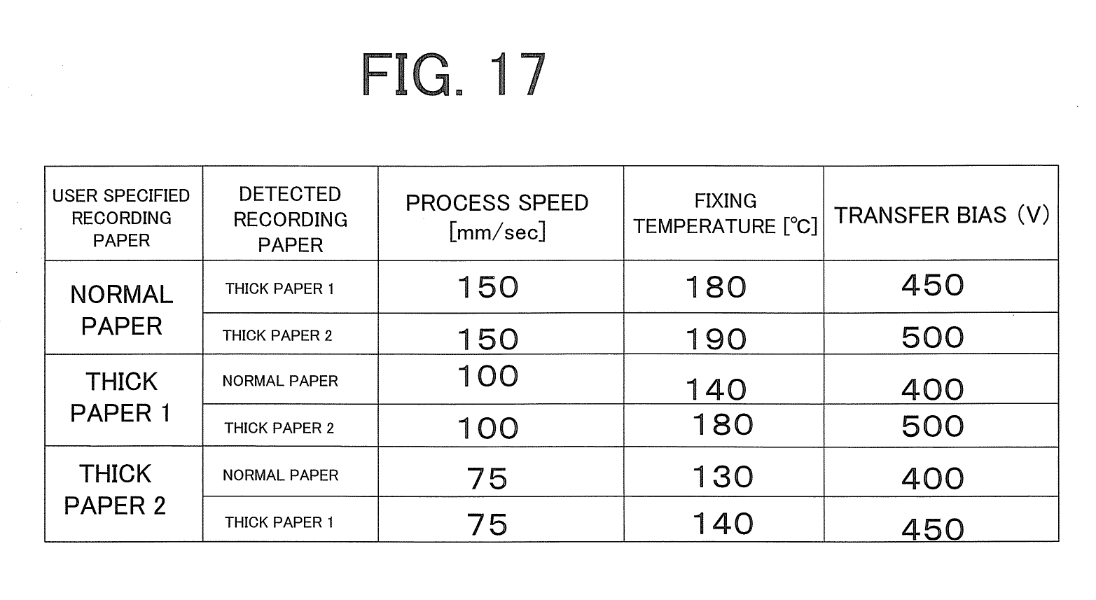

FIG. 16 is a view showing an example of a match condition table of the third embodiment. FIG. 17 is a view showing an example of a mismatch condition table of the third embodiment. As is shown in FIG. 17, in the third embodiment, the fixing temperature and the magnitude of a transfer bias are correlated with the types of the specified recording paper and the types of the recording paper P to be carried.

In the third embodiment, the condition control portion 27 controls the transfer control portion 28 in addition to the control on the fixing device control portion 24 in the first embodiment above. More concretely, the condition control portion 27 controls the transfer control portion 28 to change the magnitude of a transfer bias applied to the second transfer roller T1 to the magnitude corresponding to the recording paper P to be carried using the carried recording paper information, the specified recording paper information, and the mismatch condition table. The transfer control portion 28 controls the transfer bias application power supply 94 to change the magnitude of the transfer bias to be applied to the second transfer roller T1 under the control of the condition control portion 27. Also, the transfer control portion 28 notifies the condition change detection portion 29 of a change in the magnitude of the transfer bias.

The condition change detection portion 29 detects a completion of a change in the magnitude of the transfer bias by the notice from the transfer control portion 28.

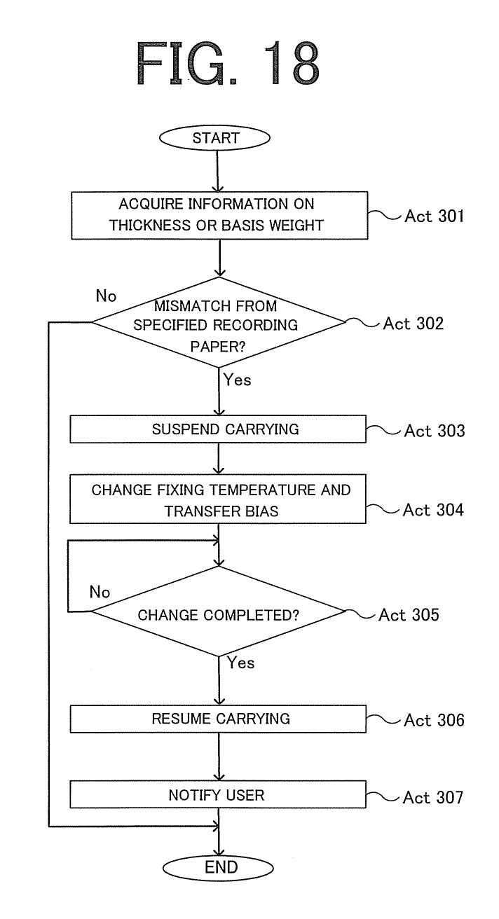

The process flow of the control on the image formation corresponding to a type of recording paper in the third embodiment will now be described using FIG. 18.

Because the contents of processing in Act 301 through Act 303 are common with those in Act 101 through Act 103 in the first embodiment above and the content of processing in Act 307 is common with that in Act 107 in the first embodiment above, descriptions thereof are omitted herein.

In Act 304, according to the notice from the recording paper determination portion 25, the condition control portion changes the fixing temperature from the temperature corresponding to the specified recording paper to the temperature corresponding to the recording paper P to be carried using the carried recording paper information, the specified recording paper information, and the mismatch condition table. Further, the condition control portion 27 changes the magnitude of the transfer bias from the magnitude corresponding to the specified recording paper to the magnitude corresponding to the recording paper P to be carried using the carried recording paper information, the specified recording paper information, and the mismatch condition table.

Subsequently, in Act 305, the condition change detection portion 29 determines whether the fixing temperature reaches the changed temperature. Also, the condition change detection portion 29 determines reception of the notice from the transfer control portion 28. If the fixing temperature does not reach the changed temperature or the condition change detection portion 29 does not receive the notice from the transfer control portion 28, the condition change detection portion 29 continues the processing in Act 305. Meanwhile, if the fixing temperature reaches the changed temperature and the condition change detection portion 29 receives the notice from the transfer control portion 28, the condition change detection portion 29 notifies the carrying control portion 22 of a completion of the change. In Act 306, the carrying control portion 22 controls the drive motors of the registration rollers R1 and R2 to resume carrying of the recording paper P according to the notice from the condition change detection portion 29.

According to the MFP of the third embodiment, even if there is a mismatch between the information on thickness or basis weight of the specified recording paper and the information on thickness or basis weight of the recording paper P to be carried, it is possible to improve an image quality of an image to be formed by changing the magnitude of the transfer bias applied during transferring to the magnitude corresponding to the recording paper P to be carried.

### Other Embodiments

The above described the first through third embodiments. However, it goes without saying that the invention can be implemented in other embodiments.

For example, the first through third embodiments described the configuration including the heating roller 11, the fixing roller 12, and the pressure roller 13 by way of example. However, the fixing device may be configured to include a heat generation source heating the fixing roller in the inside or outside of the fixing roller by omitting the heating roller.

The first through third embodiments adopt the method of rotating the heating roller 11 by the drive motor. The invention, however, is not limited to this configuration and, for example, a method of rotating the fixing roller 12 or the pressure roller 13 is also applicable.

In the first through third embodiments, a mismatch between the type of the specified recording paper and the type of the recording paper to be carried is notified to the user by an indication using the display. The invention, however, is not limited to this configuration and, for example, a mismatch may be notified to the user by sounds.

In the first through third embodiments, the user is notified of a mismatch after carrying of the recording paper is resumed. However, the notice timing is not particularly limited as long as it is after the recording paper determination portion 25 determines a mismatch between the type of the specified recording paper and the type of the recording paper to be carried.

In the first through third embodiments, the carrying control portion 22 suspends carrying of the recording paper according to the notice from the recording paper determination portion 25 and resumes carrying according to the notice from the condition change detection portion 29. However, for example, the carrying control portion 22 may decelerate carrying of the recording paper according to the notice from the recording paper determination portion 25 and accelerate carrying (for example, restore the speed to the original speed) according to the notice from the condition change detection portion 29.

The second embodiment described not only a change in the magnitude of the fixing pressure but also a change in the distance between the separation plate 18 and the nip portion N. However, the fixing pressure alone may be changed. Also, the fixing temperature may be changed as described in the first embodiment together with a change in the fixing pressure or with a change in the fixing pressure and a change in the distance between the separation plate 18 and the nip portion N.

Further, the third embodiment described not only a change in the fixing temperature but also a change in the magnitude of the transfer bias. However, the magnitude of the transfer bias alone may be changed.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the sprit of the inventions. The accompanying claims and their equivalents are intended to cover such forms or modifications as would fall within the scope and spirit of the inventions.

As has been described in detail, according to the technique described in the present specification, even if there is a mismatch between the type of the specified recording paper and the type of the recording paper to be carried, it is possible to suppress the occurrence of hot offset and paper jamming caused by winding.

What is claimed is:

1. An image forming apparatus, comprising:
a recording medium information acquisition portion that acquires carried recording medium information, which is information related to thickness of a recording medium to be carried as an image forming subject;
a recording medium determination portion that determines whether there is a mismatch between the carried recording medium information acquired by the recording medium information acquisition portion and specified recording medium information, which is information related to thickness of a specified recording medium specified by a user as an image forming subject;
a condition control portion that, if the recording medium determination portion determines the mismatch between the carried recording medium information and the specified recording medium information, changes a condition for one of transferring and fixing among image forming conditions corresponding to the specified recording medium to a condition for one of transferring and fixing corresponding to the recording medium to be carried in image formation on the recording medium to be carried;
a condition change detection portion that detects a completion of a change in the condition for one of transferring and fixing by the condition control portion; and
a carrying control portion that suspends carrying of the recording medium if the recording medium determination portion determines the mismatch between the carried recording medium information and the specified recording medium information and resumes carrying of the recording medium in response to a detection of the completion of the change in the condition for one of transferring and fixing by the condition change detection portion.

2. The apparatus according to claim 1, wherein:
the carried recording medium information is information on one of thickness and basis weight of the recording medium to be carried and the specified recording medium information is information on one of thickness and basis weight of the specified recording medium.

3. The apparatus according to claim 1, wherein:
among the image forming conditions corresponding to the specified recording medium, the condition control portion changes a fixing temperature of a fixing device provided to the image forming apparatus from a temperature corresponding to the specified recording medium to a temperature corresponding to the recording medium to be carried.

4. The apparatus according to claim 1, wherein:
among the image forming conditions corresponding to the specified recording medium, the condition control portion changes magnitude of a pressure conferred to the recording medium during fixing of the recording medium to be carried in a fixing device provided to the image forming apparatus from magnitude corresponding to the specified recording medium to magnitude corresponding to the recording medium to be carried.

5. The apparatus according to claim 4, wherein:
the fixing device provided to the image forming apparatus has a heating member heating a toner image formed on the recording medium, a pressure member forming a nip portion by pressing against the heating member and nipping and carrying the recording medium in cooperation with the heating member, and a separation guide disposed downstream of the nip portion of the heating member at a position opposing the heating member and separating the recording medium from the heating member to guide the recording medium; and
if the recording medium determination portion determines the mismatch between the carried recording medium information and the specified recording medium information, the condition control portion changes a length of a distance between the separation guide and the nip portion formed of the heating member and the pressure member from a length corresponding to the specified recording medium to a length corresponding to the recording medium to be carried.

6. The apparatus according to claim 1, wherein:
among the image forming conditions corresponding to the specified recording medium, the condition control portion changes magnitude of a transfer bias conferred to a transfer roller provided to the image forming apparatus and transferring a toner image onto the recording medium from magnitude corresponding to the specified recording medium to magnitude corresponding to the recording medium to be carried.

7. The apparatus according to claim 1, further comprising:
a notice control portion that notifies the user of a determination result of the recording medium determination portion if the recording medium determination portion determines the mismatch between the carried recording medium information and the specified recording medium information.

8. An image forming method, comprising:
acquiring carried recording medium information, which is information related to thickness of a recording medium to be carried as an image forming subject;
determining whether there is a mismatch between the acquired carried recording medium information and specified recording medium information, which is information related to thickness of a specified recording medium specified by a user as an image forming subject;
suspending carrying of the recording medium if the mismatch between the carried recording medium information and the specified recording medium information is determined;
changing a condition for one of transferring and fixing among image forming conditions corresponding to the specified recording medium to a condition for one of transferring and fixing corresponding to the recording medium to be carried in image formation on the recording medium to be carried if the mismatch between the carried recording medium information and the specified recording medium information is determined;
detecting a completion of the change in the condition for one of transferring and fixing; and
resuming carrying of the recording medium in response to a detection of the completion of the change in the condition for one of transferring and fixing.

9. The method of claim 8, wherein:
the carried recording medium information is information on one of thickness and basis weight of the recording medium to be carried and the specified recording medium information is information on one of thickness and basis weight of the specified recording medium.

10. The method according to claim 8, wherein:
among the image forming conditions corresponding to the specified recording medium, a fixing temperature of a fixing device provided to an image forming apparatus is changed from a temperature corresponding to the specified recording medium to a temperature corresponding to the recording medium to be carried.

11. The method according to claim 8, wherein:
among the image forming conditions corresponding to the specified recording medium, magnitude of a pressure conferred to the recording medium during fixing of the recording medium to be carried in a fixing device provided to an image forming apparatus is changed from magnitude corresponding to the specified recording medium to magnitude corresponding to the recording medium to be carried.

12. The method according to claim 11, wherein:
the fixing device provided to the image forming apparatus has a heating member heating a toner image formed on the recording medium, a pressure member forming a nip portion by pressing against the heating member and nipping and carrying the recording medium in cooperation with the heating member, and a separation guide disposed downstream of the nip portion of the heating member at a position opposing the heating member and separating the recording medium from the heating member to guide the recording medium; and
if the mismatch between the carried recording medium information and the specified recording medium information, is determined, a length of a distance between the separation guide and the nip portion is changed from a length corresponding to the specified recording medium to a length corresponding to the recording medium to be carried.

13. The method according to claim 8, wherein:
among the image forming conditions corresponding to the specified recording medium, magnitude of a transfer bias conferred to a transfer roller provided to an image forming apparatus and transferring a toner image onto the recording medium is changed from magnitude corresponding to the specified recording medium to magnitude corresponding to the recording medium to be carried.

14. The method according to claim 8, wherein:
a determination result is notified to the user if the mismatch between the carried recording medium information and the specified recording medium information is determined.
